(19) United States
(12) Patent Application Publication
(10) Pub. No.: US 2025/0010934 A1
(43) Pub. Date: Jan. 9, 2025

(54) Bicycle Component, Seat Post and Bicycle

(71) Applicant: Canyon Bicycles GmbH, Koblenz (DE)

(72) Inventors: Mathis Faucher, Argelliers (FR); Pierre de Marne, Plateau d'Assy (FR); Philip Oppermann, Bonn (DE); Wolfgang Kohl, Schwabach (DE)

(21) Appl. No.: 18/762,837

(22) Filed: Jul. 3, 2024

(30) Foreign Application Priority Data
Jul. 7, 2023 (DE) 20 2023 103 797.6

(51) Int. Cl. B62J 6/04; B62J 1/08; B62J 6/015

(52) U.S. Cl. CPC B62J 6/04; B62J 1/08; B62J 6/015

(57) ABSTRACT

A bicycle component including an in particular tubular hollow body, and a lighting device arranged inside the hollow body, the lighting device shining light through a shell surface of the hollow body to emit bicycle light. Further, a seat post and a bicycle are provided.

### CROSS-REFERENCE TO RELATED APPLICATION

This application claims priority to German Patent Application No. 20 2023 103 797.6 filed Jul. 7, 2023, the disclosure of which is hereby incorporated by reference in its entirety.

### BACKGROUND OF THE INVENTION

### Field of the Invention

The invention relates to a bicycle component, a seat post and a bicycle.

### Description of Related Art

For an implementation of the lighting of bicycles external lamps are most often mounted on the bicycle frame, e.g. on the handlebar and/or the seat post. Here, external lamps are, for example, disadvantageous with respect to the aesthetics and/or the aerodynamics of the bicycle. Further, external lamps are often stolen and/or damaged. Moreover, external lamps are susceptible to dust, water and/or dirt.

Furthermore, approaches exist to integrate the lighting in bicycle components such as e.g. the handlebar and/or the seat post. Holes, in particular drill holes, are provided in the bicycle component. Lamps are then arranged in or behind these holes within the bicycle component to illuminate the bicycle. Holes have the disadvantage that they lead to a structural change in the bicycle component. This can have negative effects on the strength and/or dynamic behavior of the bicycle component. Furthermore, dust, water and/or dirt can penetrate the bicycle component through holes. There is also the possibility that holes, e.g. drilled holes, may lead to wear, in particular corrosion, of the bicycle component.

### SUMMARY OF THE INVENTION

It is an object of the invention to provide a bicycle component, a seat post and a bicycle with an improved integrated bicycle lamp.

The object is achieved according to the invention with a bicycle component as described herein, a seat post as described herein and a bicycle as described herein.

The bicycle component according to the invention is in particular a bicycle lighting component. The bicycle component is preferably a bicycle component for illuminating a bicycle. The bicycle component comprises an in particular tubular hollow body. The hollow body is in particular a tube element and/or a tubular profile. The hollow body has in particular a hollow cylindrical shape with a circular, oval or square cross section. The bicycle component further comprises a lighting device arranged inside the hollow body. The lighting device is configured in particular to emit a red and/white light to illuminate a bicycle. The lighting device comprises in particular one or a plurality of LEDs, preferably red and/or white LEDs. To emit light for the bicycle lighting, the lighting device emits light through a shell surface of the hollow body. The shell surface is preferably an outer surface, in particular the entire outer surface of the hollow body. In other words, the bicycle component is designed such that the lighting device shines through or emits light through the shell surface of the hollow body. Advantageously, the bicycle component according to the invention implements in particular an integrated bicycle lighting, preferably integrated completely in the bicycle frame. The shell surface itself, in particular the material of the shell surface, is preferably translucent.

In a preferred design, the shell surface is closed, in particular completely. In particular, the shell surface is designed without holes and/or openings, so that the shell surface does not have any holes and/or openings.

In a preferred embodiment, the shell surface, in particular the hollow body, is made of composite material, in particular CFRP and/or GFRP.

In a preferred embodiment, the shell surface, in particular the hollow body, is at least partially coated, e.g. painted. In particular, the coating is opaque. It is therefore preferable that the lighting device does not shine through the shell surface in areas of the coating.

In a preferred embodiment, the shell surface has at least one window for transillumination with the lighting device. In particular, the window is designed as a single piece, also known as integral, with the shell surface. Preferably, the window is made of the same material as the shell surface. In particular, the window has a round or square shape. In particular, the area of the window is less than 30% of the surface area of the casing, preferably less than 20%, particularly preferably less than 10%. The lighting device is arranged, at least partially, behind the window. The window is in particular a translucent window.

In a preferred embodiment, the window corresponds to a non-coated or light-permeably coated area of the shell surface, in particular a partial area. Thus, it is preferred that the shell surface is coated, in particular for the greater part, in a non-light permeably manner, whereas to form the translucent window, one or a plurality of partial areas are not coated or light-permeably coated, i.e. provided in particular with a light-permeable coating. It is possible for the window to have a colored, translucent coating so that light emitted as white light by the lighting device is emitted as colored by the coating. The colored coating is in particular red or orange.

In a preferred embodiment, the hollow body is configured to be resilient, in particular a leaf spring. The design of the resilient hollow body is particularly preferred in a design in which the bicycle component is a seat post, preferably designed as a leaf spring device, and/or a seat post tube of a seat post.

The resilient hollow body is designed in particular to absorb forces in the transverse direction to the hollow body in a resilient manner. The resilient hollow body, in particular in the form of a leaf spring, preferably has a spring travel of 2 mm to 50 mm, preferably of 5 mm to 30 mm, particularly preferably of 15 mm to 25 mm. The spring travel of the resilient hollow body runs in particular in the transverse and/or radial direction of the hollow body.

In a preferred configuration, the lighting device is connected to a sleeve that can be inserted into the hollow body. The sleeve has a sleeve body, in particular a flexible sleeve body. In particular, the sleeve is a plug-in sleeve. The lighting device is in particular integrated into the sleeve. In particular, the sleeve has substantially the same outer shape as the inner shape of the hollow body, with the outer shape of the sleeve in particular being of a smaller dimension. The sleeve is preferably closed on one or both sides, in particular at the base surfaces.

In a preferred embodiment, the sleeve, in particular the sleeve body, is designed for the resilient absorption of forces transmitted to the hollow body, in particular transverse forces. This design of the sleeve with resilient force absorption is particularly preferred when the bicycle component is designed with a resilient hollow body. It is preferable for the sleeve to absorb the spring movement of the hollow body, in particular to move along. It is preferable that the sleeve is flexible, in particular bendable. Preferably, the sleeve is made of plastic, in particular consists of plastic. The sleeve is designed in particular to resiliently absorb forces in the transverse direction to the hollow body. The sleeve preferably has a spring travel of 2 mm to 50 mm, preferably of 5 mm to 30 mm, particularly preferably of 15 mm to 25 mm. The spring travel of the sleeve runs in particular in the transverse direction and/or the radial direction of the sleeve.

In a preferred embodiment, the sleeve has a power source and/or a control unit. In particular, the power source is an in particular rechargeable battery. The control unit comprises in particular a PCB, preferably consists of a PCB. The control unit is configured in particular to actuate the lighting device, preferably to switch the same on and off. The control unit is in particular configured to be controller by a user either in a wired or a wireless manner. For wireless control, the control unit comprises in particular a radio module, e.g. a Bluetooth module or a WiFi module. It is preferred for the sleeve to comprise a connector for current or signal transmission for the operation of the lighting device. The connector is in particular a port, preferably a plug or a socket. In particular, the lighting device, the power source and/or the control unit is connected directly to the sleeve. Preferably, the lighting device, the power source and/or the control unit is permanently connected and/or movable together and/or integral with the sleeve.

In a preferred embodiment, the sleeve and/or the hollow body has a device, in particular a shape, for clearly defining the relative position between the sleeve and the hollow body. Preferably, the sleeve and/or the hollow body has a form-fit connector, such as a groove and/or an irregular shape for relative position definition. The position definition device is designed in particular to clearly define the relative radial position between the sleeve and the hollow body. Preferably, the position definition device defines a single position.

In a preferred embodiment, the hollow body has a sleeve connector, in particular arranged in an interior of the hollow body, for transmitting current and/or signals to the sleeve for operating the lighting device. It is preferred that the sleeve connector is designed as a counterpart of the connector of the sleeve. The sleeve connector is in particular a port, preferably a plug or a socket.

In a preferred embodiment, the sleeve connector and the connector of the sleeve are designed as a plug-in connection, in particular one that slides into the other. In particular, the sleeve connector has a plug and the connector of the sleeve has a socket, or vice versa.

In a preferred embodiment, the sleeve and/or the hollow body has a fixing device for fixing the sleeve within the hollow body. The fixing device is designed in particular for force-fit and/or form-fit fixing. In particular, the fixing device has a damping device for damping forces between the sleeve and the hollow body. The fixing device is preferably designed for radial clamping between the sleeve and the hollow body, in particular for releasable radial clamping. In particular, the fixing device has a preferably circumferential clamping jaw which applies a radial clamping against the inner side of the hollow body, in particular in a releasable manner. For radial clamping, the fixing device has in particular a preferably axial screwing device that triggers the radial clamping. The damping device comprises in particular on or more O-rings, in particular made of rubber.

It is preferred that instead or in addition to the design of the sleeve with resilient force absorption, in particular the flexible design of the sleeve, the connection between the sleeve and the hollow body, in particular the fixing device, is configured to absorb forces, in particular transversal forces, transmitted from the hollow body to the sleeve. The connection, in particular the fixing connection, is preferably configured to be damping and/or resilient.

In a preferred embodiment, the hollow body has a hollow body connector, in particular arranged in a bore of the shell surface, for transmitting current and/or signals to the sleeve for operating the lighting device. If the shell surface has a bore, it is preferred that the bore only receives the hollow body connector and/or a cable of the hollow body connector. It is preferred that the bore is not configured for light transmission of the lighting device. The current and/or signal transmission of the hollow body connector occurs in particular from the hollow body connector to the connector of the sleeve, preferably via the sleeve connector. In particular, the hollow body connector can be used to establish a preferably subsequent power connection for charging the battery of the sleeve.

In a preferred embodiment, the hollow body is a seat post or a seat post tube or a handlebar or a handlebar stem or a frame tube. The seat post or the seat post tube is particularly flexible and/or resilient, preferably in the form of a leaf spring. The seat post design or the seat post tube design corresponds in particular to the seat post or the seat post tube described in EP2415657A1 or in EP2683598A1, in particular according to one of the corresponding patent claims therein. The frame tube is in particular a seat stay, a top tube, a seat tube, a down tube, a fork, a head tube, a chain stay or a down tube. The seat post design corresponds in particular to that of the S14 VCLS 2.0 CF or S15 VCLS 2.0 CF seat post from Canyon.

The seat post according to the invention is in particular a seat post with a leaf spring device. The seat post has one or two seat post tubes. The seat post tube or both seat post tubes are preferably resilient seat post tubes, particularly preferably designed as leaf springs. The seat post tube or both seat post tubes is a bicycle component with one or more features of the bicycle component according to the invention.

The bicycle according to the invention is in particular an e-bike or a pedelec. The bicycle comprises at least one bicycle component with one or more features of the bicycle component according to the invention, and/or the bicycle has a seat post with one or more features of the seat post according to the invention.

In a preferred embodiment, the bicycle has a bicycle battery, in particular connected to a bicycle frame of the bicycle. The bicycle battery is preferably connected directly to the bicycle frame, in particular to a down tube of the bicycle frame. In particular, the bicycle battery is a battery for powering the bicycle, preferably an e-bike or pedelec. The bicycle battery preferably has at least 300 Wh. It is preferred that the lighting device is connected to the bicycle battery, in particular in a wired manner, for current transmission.

In a preferred embodiment, the bicycle comprises a motor with light control. The lighting device is connected to the light control of the motor, in particular in w wired or wireless manner, in order to control the light emission of the lighting device. The light control of the motor is in particular connected to the control unit. In case of a wired connection, it is preferred that one or more cables of the wired connection run internally through the hollow body and/or at least partially internally through tube elements of the bicycle frame.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying drawings.

In the figures:

FIG. 1 is a schematic sectional view of an embodiment of a bicycle component according to the invention,

FIG. 2 shows the bicycle component of FIG. 1 connected to a bicycle battery,

FIGS. 3a-b are schematic sectional views of a further embodiment of a bicycle component according to the invention, and

FIG. 4 is a schematic detail illustration of an embodiment of a bicycle according to the invention with an embodiment of a seat post according to the invention with a further embodiment of a bicycle embodiment according to the invention.

### DESCRIPTION OF THE INVENTION

In the Figures, similar or identical components or elements are identified by the same reference numerals or variations thereof. In particular in the interest of improved clarity, preferably elements already identified are not provided with reference numerals in all Figures.

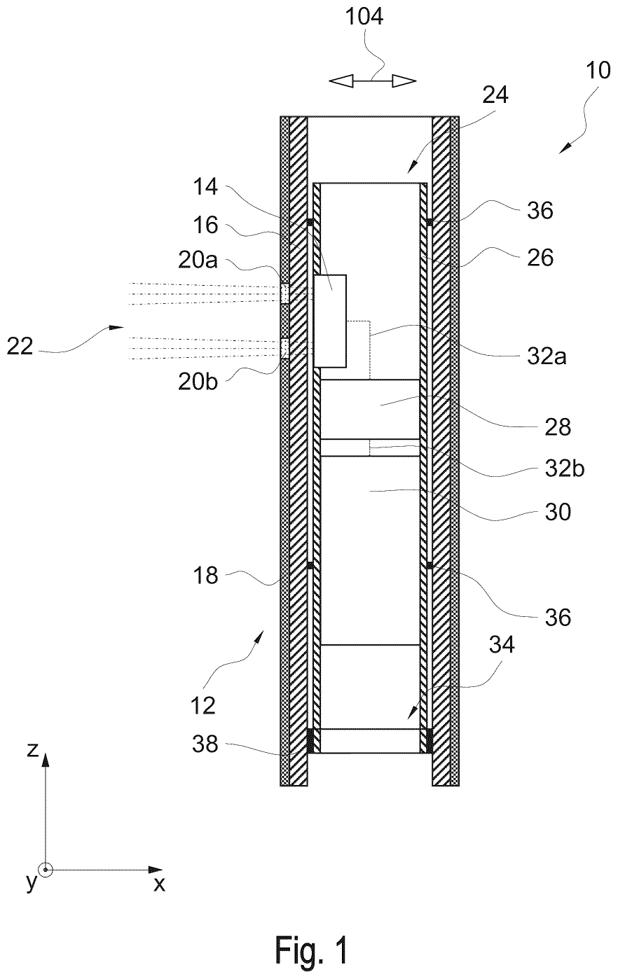

FIG. 1 shows an embodiment of a bicycle component 10 according to the invention, which is preferably a seat post tube.

The bicycle component 10 comprises a hollow body 12 having a shell surface 16. The hollow body 12 has in particular a hollow cylindrical shape with a round or oval cross section.

The shell surface 16 has a preferably opaque coating 18 on the outer surface, the coating 18 is illustrated as being interrupted by two windows 20a, 20b. The windows 20a, 20b correspond in particular to a non-coated area of the lateral surface 16 or a translucent coated area of the lateral surface 16.

A sleeve 24 is arranged inside the hollow body 12, in particular inserted. The sleeve 24 is fixed, preferably releasably, within the hollow body preferably by means of a fixing device 34, in particular a positive fixing device. The fixing device 34 is preferably designed for radial clamping, in particular for releasable radial clamping, between the sleeve 24 and the hollow body 12. For radial clamping, the fixing device 34 comprises a preferably circumferential clamping jaw 38 which applies an in particular releasable radial clamping force against the inside of the hollow body 12 in order to fix the sleeve 24 within the hollow body 24. The releasability of the fixing device 34 is implemented in particular by a preferably axial screwing device (not illustrated) which triggers the radial clamping. In particular, the fixing device 34 comprises a damping device 36 for damping forces between the sleeve 24 and the hollow body 12. The damping device is shown as two O-rings 36, in particular made of rubber.

The sleeve 12 includes a lighting device 14 for generating a bicycle light. In particular, the lighting device 14 comprises at least one LED, preferably a red and/or white LED. The lighting device 14 is arranged behind the windows 20a, 20b, in particular on the end face, so that the lighting device 14 shines through the shell surface 16 of the hollow body 12 and out of the windows 20a, 20b to emit the bicycle light. The transillumination and thus the emission of light is shown schematically by the broken lines 22. In particular, the lighting device does not shine through the opaque coating 18 of the shell surface. The shell surface 16 itself, in particular the material of the shell surface 16, is designed to be in particular translucent. The shell surface 16 preferably comprises composite material, in particular CFRP and/or GFRP, and is preferably made thereof.

To operate the lighting device 14, the sleeve 24 comprises in particular a control unit 28 preferably comprising a PCB and/or a power source comprising a battery 30. In particular, the battery 30 is rechargeable. The signal and/or power transmission is preferably carried out by means of cables 32a, 32b.

In a preferred embodiment, the hollow body 12 is configured to be resilient, in particular a leaf spring. Furthermore, it is preferred that the sleeve 24, in particular the sleeve body 26, and/or the connection between the sleeve 24 and the hollow body 12, is configured to be force-absorbing, preferably resilient. A spring function of the bicycle component 10, in particular of the hollow body 12 and the sleeve 24, is thus implemented during a spring movement of the bicycle component 10, for example a bending movement in particular of the hollow body 12, in the xy plane, e.g. in the direction of the arrow 104.

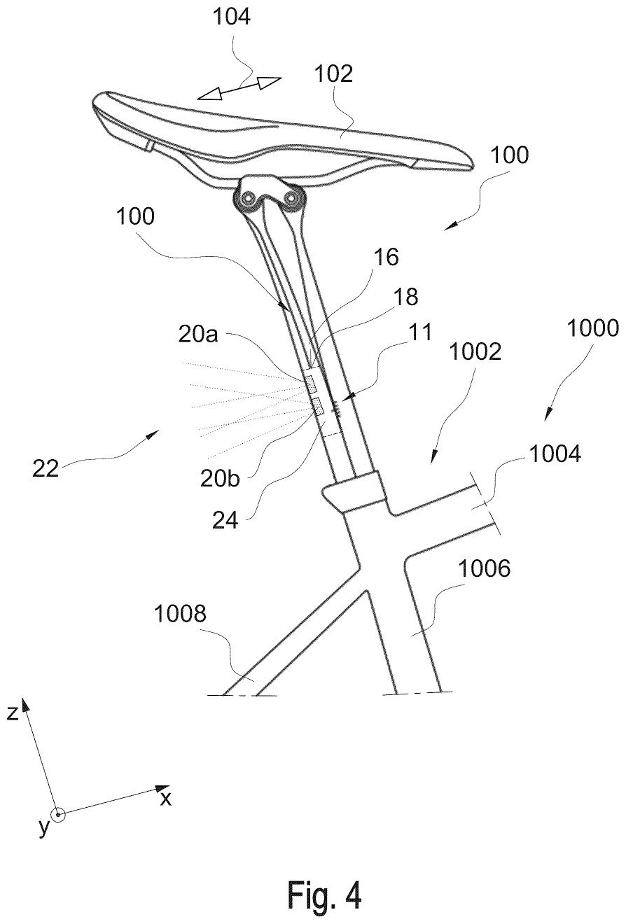

Preferably, the windows 20a, 20b are arranged opposite the direction of travel of a bicycle 1000 (see, for example, FIG. 4), in particular when the bicycle component 10 is designed as a seat post tube. Thus, preferably, a rearward light of the bike 1000 can be emitted.

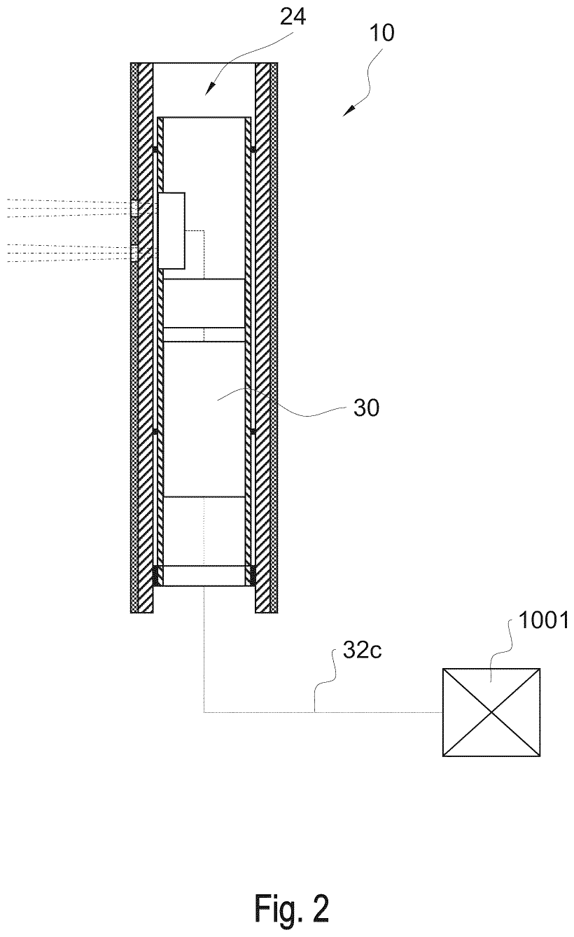

FIG. 2 shows the embodiment of the bicycle component 10 of FIG. 1, wherein the sleeve 24 is connected to a bicycle battery 1001 (shown schematically), in particular the battery 30, via a cable 32c to supply power. The bicycle battery 1001 is in particular a pedelec battery and/or e-bike battery. With this design in particular, it is also possible to omit the battery 30 from the sleeve.

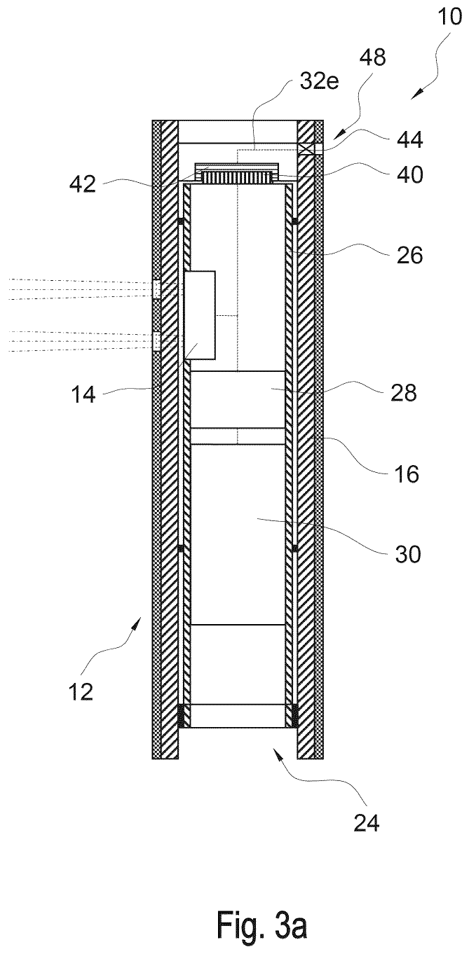

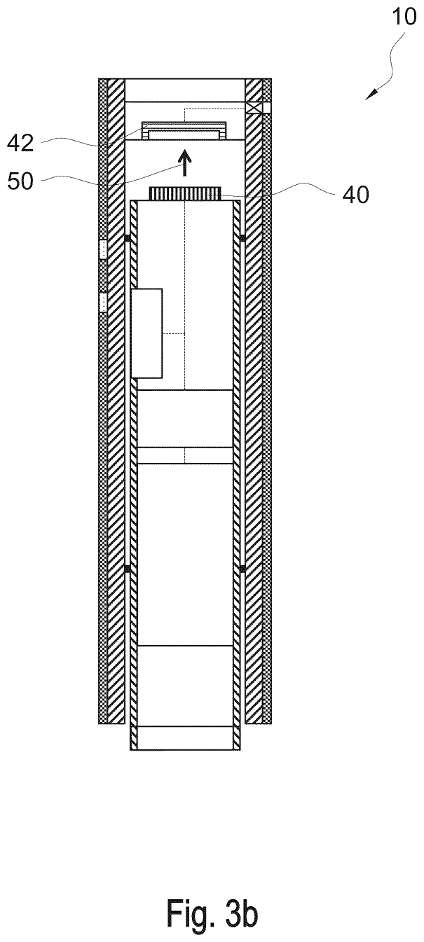

FIG. 3a shows a further embodiment of a bicycle component 10 according to the invention, the embodiment being based on that shown in FIG. 1.

In contrast to the design in FIG. 1, the sleeve 24 in FIG. 3a comprises a connector 40 for transmitting power and/or signals for the operation of the lighting device 14.

The connector 40 shown is a plug which, when the sleeve 24 is inserted into the hollow body 12, establishes a current- and/or signal-transmitting connection with a sleeve connector 42 of the hollow body 12, the sleeve connector 42 being designed as a socket for the plug.

The sleeve connector is connected, e.g. via a cable 32e, in a current- and/or signal-transmitting manner to a hollow body connector 44 arranged in a bore 48 in the shell surface 16 of the hollow body 12. A power and/or signal transmission device can be connected (not illustrated) to the hollow body connector 44 from outside, in particular to charge the battery 30 of the sleeve 24 and/or to perform an actuation by the control unit 28, in particular a switch on/off signal. The hollow body connector 44 can comprise e.g. a USB-C port for power supply.

FIG. 3b shows the bicycle component 10 of FIG. 3a with the sleeve 24 in a state of insertion (illustrated by arrow 50) prior to the connection of the plug of the connector 40 with the socket of the sleeve connector 42.

FIG. 4 shows an embodiment of a bicycle 1000 according to the invention, the illustration of the bicycle 1000 showing only a part of the frame 1002 with a part of the seat stay 1008, a part of the top tube 1004 and a part of the seat tube 1004.

An embodiment of the seat post 100 of the invention is arranged in the seat tube 1004.

The seat post 100 has two seat post tubes 10, 11. The design of the seat post 100 corresponds in particular to that of the S14 VCLS 2.0 CF or S15 VCLS 2.0 CF seat post from Canyon.

The seat post tube 10 comprises an internal sleeve 24 which is in particular inserted thereinto. The design of the sleeve 24 corresponds substantially in particular to that of one of FIGS. 1-3a. The shell surface 16 of the seat post tube 10 comprises an in particular opaque coating 16 on the outer surface, with two windows 20a, 20b being provided which correspond to a non-coated area of the shell surface 16 or are coated in a translucent manner.

By means of a lighting device 14 (not illustrated) of the sleeve 24, light 22 of the bicycle lighting, in particular rearward light, can be emitted through the windows 20a, 20b.

The seat post tube 11 is in particular of common design, hollow and without internal lighting device 14 and/or sleeve 24.

The seat post 100 illustrated is designed in particular as a leaf spring device, the seat post 100 preferably corresponding to a leaf spring, with the seat post tubes 10, 11 being of flexibly resilient design. The seat post 100 is designed in particular for absorbing forces in the xy plane, e.g. in the direction of the arrow 104. The forces act, for example, because of a rider (not illustrated) sitting on the seat 102 connected with the seat post 100.

Instead or in addition to the embodiment illustrated, in which the bicycle component 10 corresponds to a seat post tube, it is preferably also possible that a bicycle component according to the invention corresponds to the seat stay 1008, the top tube 1004 and/or the seat tube 1004, in particular that the bicycle lighting is designed correspondingly.

1. A bicycle component comprising:
an in particular tubular hollow body, and
a lighting device arranged inside the hollow body,
the lighting device shining light through
a shell surface of the hollow body to emit bicycle light.

2. The bicycle component according to claim 1, wherein the shell surface is designed in a closed manner, in particular completely closed.

3. The bicycle component according to claim 1, wherein the shell surface comprises in particular translucent composite material such as CFRP and GFRP, the shell surface preferably being made thereof.

4. The bicycle component according to claim 1, wherein the shell surface is at least partially coated, for example painted.

5. The bicycle component according to claim 1, wherein the shell surface comprises at least one window for transillumination by the lighting device.

6. The bicycle component according to claim 5, wherein the window corresponds to a non-coated or translucently coated area, in particular a partial area, of the shell surface.

7. The bicycle component according to claim 1, wherein the hollow body is designed to be resilient, in particular in the form of a leaf spring.

8. The bicycle component according to claim 1, wherein the lighting device is connected to a sleeve insertable into the hollow body, the sleeve comprising an in particular flexible sleeve body.

9. The bicycle component according to claim 8, wherein the sleeve, in particular the sleeve body, is designed to resiliently absorb forces, in particular transverse forces, transmitted by the hollow body.

10. The bicycle component according to claim 8, wherein the sleeve comprises a power source and/or a control unit, as well as in particular a connector for current and/or signal transmission for the operation of the lighting device.

11. The bicycle component according to claim 8, wherein the sleeve and/or the hollow body comprises a device, in particular a shape, for a unique position definition between the sleeve and the hollow body.

12. The bicycle component according to claim 8, wherein the hollow body comprises a sleeve connector for power and/or signal transmission to the sleeve for the operation of the lighting device, said sleeve connector being arranged in particular inside the hollow body.

13. The bicycle component according to claim 12, wherein the sleeve connector and a connector of the sleeve are designed as an in particular insertable plug-in connection.

14. The bicycle component according to claim 8, wherein the sleeve and/or the hollow body comprises a fixing device for an in particular positive fixation of the sleeve in the hollow body.

15. The bicycle component according to claim 1, wherein the hollow body comprises a hollow body connector for power and/or signal transmission for the operation of the lighting device, said hollow body connector being arranged in particular in a bore in the shell surface.

16. The bicycle component according to claim 1, wherein the hollow body is a seat post and/or a seat post tube and/or a handlebar and/or a handlebar stem and/or a frame tube.

17. A seat post comprising one or two seat post tubes, which are preferably resilient, particularly preferred designed resiliently in the form of leaf springs, one or both seat post tubes being a bicycle component according to claim 1.

18. A bicycle, in particular an e-bike or a pedelec, comprising at least one bicycle component according to claim 1.

19. The bicycle according to claim 18, wherein the bicycle comprises a bicycle battery which is connected in particular to a bicycle frame of the bicycle, the lighting device is connected to the bicycle battery for power supply.

20. The bicycle according to claim 18, wherein the bicycle comprises a motor with a light control, the lighting device being connected to the light control of the motor, in a wired or wireless manner, to control light emission by the lighting device.
